(19) United States
(12) Patent Application Publication
(10) Pub. No.: US 2013/0087361 A1
(43) Pub. Date: Apr. 11, 2013

(54) FOAMED RESIN COMPOSITION, WIRE AND CABLE

(71) Applicants: Masafumi KAGA, Hitachi (JP); Akinari NAKAYAMA, Hitachinaka (JP); Masahiro ABE, Hitachi (JP)

(72) Inventors: Masafumi KAGA, Hitachi (JP); Akinari NAKAYAMA, Hitachinaka (JP); Masahiro ABE, Hitachi (JP)

(73) Assignee: HITACHI CABLE, LTD., TOKYO (JP)

(21) Appl. No.: 13/611,075

(22) Filed: Sep. 12, 2012

(30) Foreign Application Priority Data
Oct. 11, 2011 (JP) 2011-224038

(51) Int. Cl. H01B 7/17; H01B 7/00; C08K 3/30; C08L 25/08; C08K 3/38

(52) U.S. Cl. 174/102 R; 521/139; 174/110 SR

(57) ABSTRACT

A foamed resin composition includes syndiotactic polystyrene, and a polyolefin resin of not less than 5.3 parts by weight and not more than 54 parts by weight relative to 100 parts by weight of the syndiotactic polystyrene. Alternatively, a foamed resin composition includes syndiotactic polystyrene, and fluorine-resin-containing powder of not less than 0.5 parts by weight and not more than 10 parts by weight relative to 100 parts by weight of the syndiotactic polystyrene.

The present application is based on Japanese patent application No.2011-224038 filed on Oct. 11, 2011, the entire contents of which are incorporated herein by reference.

### BACKGROUND OF THE INVENTION

1. Field of the Invention

The invention relates to a foamed resin composition, and a wire and a cable using the foamed resin composition.

2. Description of the Related Art

In accordance with progress of information networks in recent years, a high speed and large capacity wire is required for transmitting information. Accordingly, transmission systems have also been developed, and nowadays, a method in which positive and negative voltages are applied to a two-core cable, so-called differential transmission, is adopted in many devices.

In the differential transmission system, while resistance to exogenous noise is high, a signal transmission time difference between two wires (delay time difference: skew) is strictly controlled. The skew is caused by a delay time difference between individual wires, i.e., by a dielectric constant of insulation of wire. Therefore, controlling the foaming degree of the insulation is the most important factor.

Conventionally, polyethylene (PE), etc., having a low dielectric tangent is used as an insulation material for a wire, etc., and a dielectric constant 8 is reduced by highly foaming PE (see, e.g., Japanese patent No.4123087).

### SUMMARY OF THE INVENTION

Such insulations use polyethylene having relatively low heat resistance and is highly foamed. Thus, there are problems that mechanical strength is low due to the small amount of resin in the insulation and heat of soldering at the time of connecting a connector melts the resin and deforms the insulation at a connecting portion the connector, resulting in a decrease in transmission characteristics.

When taking into consideration heat deformation resistance at the time of connecting the connector, it is necessary to use a resin material having better heat resistance than polyethylene, etc. A conventional technique is known in which a resin having a syndiotactic structure is used for an application requiring high heat resistance (see, e.g., JP-A-H01-182344). A syndiotactic resin has a structure with regularly arranged molecules, is rapidly crystallized, has mechanical strength and is excellent in heat resistance. Accordingly, such a syndiotactic resin excellent in heat resistance could be used as an insulation material.

However, the syndiotactic resin is excellent in heat resistance but low in melt viscosity due to the structure thereof and it is difficult to form a highly foamed or uniformly foamed layer. Therefore, it is not suitable to use as a wire insulation which is foamed in order to decrease a dielectric constant.

Accordingly, it is an object of the invention to provide a foamed resin composition to compose a foamed insulation layer that is excellent in uniformity of the foamed state and heat resistance, and a wire and a cable having such a foamed insulation layer.
(1) According to one embodiment of the invention, a foamed resin composition comprises:
   syndiotactic polystyrene; and
   a polyolefin resin of not less than 5.3 parts by weight and not more than 54 parts by weight relative to 100 parts by weight of the syndiotactic polystyrene.
(2) According to another embodiment of the invention, a foamed resin composition comprises:
   syndiotactic polystyrene; and
   fluorine-resin-containing powder of not less than 0.5 parts by weight and not more than 10 parts by weight relative to 100 parts by weight of the syndiotactic polystyrene.

In the above embodiment (1) or (2) of the invention, the following modifications and changes can be made.
(i) The foamed resin composition further comprising: an inorganic compound with a layered crystal structure.
(ii) The inorganic compound comprises clay, boron nitride, molybdenum disulfide, tungsten disulfide, melamine cyanurate, mica, talc, glass flake and hydrotalcite.
(3) According to another embodiment of the invention, a wire comprises:
   a conductor; and
   a foamed insulation layer on the conductor or on another layer on the conductor,
   wherein the foamed insulation layer mainly comprises the foamed resin composition according to the embodiment (1) or (2).
(4) According to another embodiment of the invention, a cable comprises:
   a conductor;
   a foamed insulation layer on the conductor or on another layer on the conductor;
   a shield on the foamed insulation layer or on another layer on the foamed insulation layer; and
   a sheath on the shield or on another layer on the shield,
      wherein the foamed insulation layer mainly comprises the foamed resin composition according to the embodiment (1) or (2).

In the above embodiment (4) of the invention, the following modifications and changes can be made.
(iii) The conductor comprises two parallel conductor wires.

### EFFECTS OF THE INVENTION

One embodiment of the invention can offer a foamed resin composition to compose a foamed insulation layer that is excellent in uniformity of the foamed state and heat resistance, and a wire and a cable having such a foamed insulation layer.

### BRIEF DESCRIPTION OF THE DRAWINGS

Next, the present invention will be explained in more detail in conjunction with appended drawings, wherein:

FIG. 1 is a cross sectional view showing a wire in a second embodiment;

FIG. 2 is a cross sectional view showing a cable in a third embodiment;

FIG. 3 is a cross sectional view showing a twinax cable in a fourth embodiment;

FIG. 4 is a cross sectional view showing a twinax cable in the fourth embodiment;

FIG. 5 is a cross sectional view showing a twinax cable in the fourth embodiment;

FIG. 6 is a cross sectional view showing a twinax cable in the fourth embodiment;

FIG. 7 is a graph showing variation in a converted foaming degree F. over time in Example;

FIG. 8 is a graph showing variation in the converted foaming degree F. over time in Example; and

FIG. 9 is a graph showing variation in the converted foaming degree F. over time in Comparative Example;

### DETAILED DESCRIPTION OF THE PREFERRED EMBODIMENTS

### First Embodiment

### Foamed Resin Composition

One of foamed resin compositions of the first embodiment contains syndiotactic polystyrene and a polyolefin resin of not less than 5.3 parts by weight and not more than 54 parts by weight per 100 parts by weight of the syndiotactic polystyrene.

In addition, another foamed resin composition of the first embodiment contains syndiotactic polystyrene and fluorine-resin-containing powder of not less than 0.5 parts by weight and not more than 10 parts by weight per 100 parts by weight of the syndiotactic polystyrene.

The reason for using not a fluorine resin but powder containing fluorine resin (fluorine-resin-containing powder) here is that a fluorine resin has a high melting point and it is difficult to disperse in a material if it is not in the form of powder.

Unlike molecular structural arrangement of typical polystyrene, syndiotactic polystyrene has a symmetrical structure in which molecules are regularly and alternately arranged. It is considered that this provides excellent heats resistance and chemical resistance and affects stability of molded products formed using syndiotactic polystyrene. The melting point of syndiotactic polystyrene is high such as about 270° C. and, when used as an insulation layer of a wire, etc., syndiotactic polystyrene withstands heat at the time of soldering an end portion of the wire and deformation is suppressed. Furthermore, among resins, syndiotactic polystyrene has relatively small specific weight and is excellent in dielectric characteristics at high frequency such as in a wire, etc.

However, since syndiotactic polystyrene has a significantly low melt viscosity of about 80 Pa·s, foam molding using syndiotactic polystyrene alone is difficult and distribution of air bubbles becomes non-uniform. Use of syndiotactic polystyrene alone as a major constituent of a foamed body is not suitable.

Thus, in the first embodiment, syndiotactic polystyrene to which a polyolefin resin or fluorine-resin-containing powder is added is kneaded by a molding machine so that the additive is dispersed in the syndiotactic polystyrene, thereby improving a melt viscosity of a foamed resin composition to a level suitable for foam molding.

Polyolefin is not specifically limited as long as it is a polymer having a unit polymerized with olefin, and is, e.g., one of low-density polyethylene, linear low-density polyethylene, very low-density polyethylene, ethylene-hexene copolymer, ethylene-octene copolymer, ethylene-vinyl acetate copolymer, ethylene ethyl acrylate copolymer, ethylene methyl acrylate copolymer, ethylene-methyl methacrylate copolymer, polypropylene, ethylene copolymerized polypropylene and reactor-blended type polypropylene, or mixture of two or more thereof.

The syndiotactic polystyrene and the polyolefin resin are mixed at a polymerization ratio of 95/5 to 65/35. In other words, the polyolefin resin is contained in the foamed resin composition in an amount of not less than 5.3 parts by weight and not more than 54 parts by weight per 100 parts by weight of the syndiotactic polystyrene.

When the amount of the polyolefin resin is less than 5.3 parts by weight, the melt viscosity of the foamed resin composition is not sufficient. On the other hand, when the amount of the polyolefin resin is more than 54 parts by weight, a proportion of the syndiotactic polystyrene is small and heat resistance of the foamed resin composition decreases.

The fluorine-resin-containing powder is a particulate substance of, e.g., tetrafluoroethylene-hexafluoropropylene copolymer, tetrafluoroethylene-perfluoroalkoxyethylene copolymer, polyvinylidene fluoride, polytetrafluoroethylene, vinylidene fluoride-hexafluoropropylene copolymer, tetrafluoroethylene-propylene copolymer or ethylene-tetrafluoroethylene copolymer, having a particle size of 1 to 500 μm. In addition, these particulate substances surface-treated with silane coupling agent, acrylic resin, phenolic resin, titanate-based coupling agent, melamine resin, organic resin aliphatic acid or metallic soap, etc., may be used.

The fluorine-resin-containing powder is contained in the foamed resin composition in an amount of not less than 0.5 parts by weight and not more than 10 parts by weight per 100 parts by weight of the syndiotactic polystyrene.

When the amount of the fluorine-resin-containing powder is less than 0.5 parts by weight, the melt viscosity of the foamed resin composition is not sufficient. On the other hand, when the amount of the fluorine-resin-containing powder is more than 10 parts by weight, distribution of air bubbles in a foamed body formed of the foamed resin composition becomes non-uniform.

In addition, in the first embodiment, an inorganic compound having a layered crystal structure is further added to the syndiotactic polystyrene to which the polyolefin resin or the fluorine-resin-containing powder is added, thereby improving flame retardancy of the foamed resin composition.

One of the reasons for which flame retardancy is improved by adding the inorganic compound having a layered crystal structure is considered that the inorganic compound having a layered crystal structure is peeled off in layers by shearing of a foaming extruder at the time of foam molding of the foamed resin composition and is dispersed in the resin composition which is foamed (i.e., a bubble wall is formed). It is presumed that, due to a synergetic effect of this and flame retardancy inherent to the polyolefin or the fluorine-resin-containing powder, a carbon film is formed at the time of burning.

The inorganic compound having a layered crystal structure is, e.g., clay, boron nitride, molybdenum disulfide, tungsten disulfide, melamine cyanurate, mica, talc, glass flake and hydrotalcite.

The added amount of the inorganic compound having a layered crystal structure is not specifically limited and it is possible to use in an amount which does not inhibit dielectric characteristics. For example, it is preferable that the inorganic compound having a layered crystal structure be contained in the foamed resin composition in an amount of not less than 0.1 parts by weight per 100 parts by weight of the syndiotactic polystyrene to which the polyolefin resin or the fluorine-resin-containing powder is added.

Furthermore, the foamed resin composition may contain additives such as antioxidant, age inhibitor, lubricant, processing aid, inorganic filler, flame retardant, flame-retardant aid, surface active agent, antistatic agent, softener, foaming agent, foam-nucleating agent, light stabilizer, ultraviolet absorber and plasticizer, etc.

### Second Embodiment

### Wire

It is possible to use the foamed resin composition in the first embodiment as a material of a foamed insulation layer of a wire. In the wire, the foamed insulation layer is formed on a conductor or on another layer on the conductor. An example of the wire will be described below.

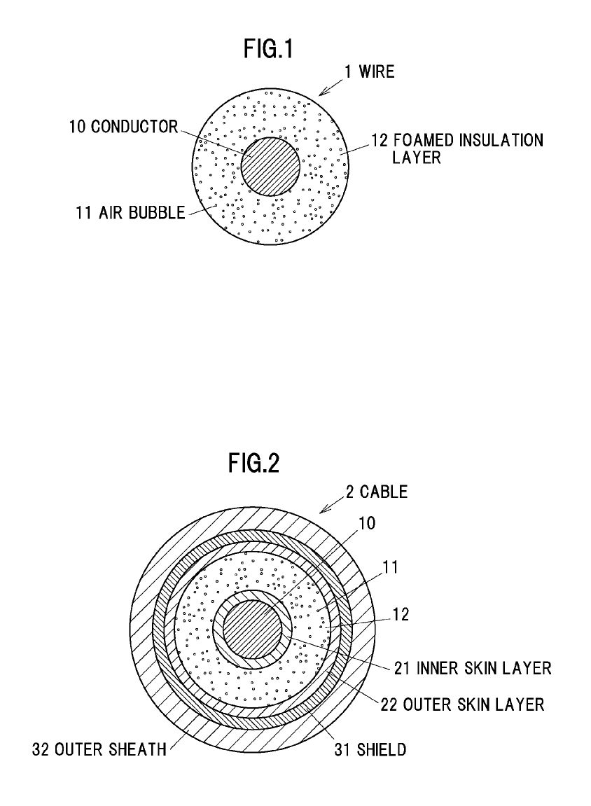

FIG. 1 is a cross sectional view showing a wire 1 in a second embodiment. The wire 1 has a conductor 10 and a foamed insulation layer 12 thereon. The foamed insulation layer 12 includes plural air bubbles 11.

The conductor 10 is formed of a conductive material such as copper or various alloys. The conductor 10 may be a conductor wire formed by plating a conductor with silver, tin, nickel or gold, etc.

The foamed insulation layer 12 is formed of the foamed resin composition in the first embodiment. The foamed insulation layer 12 may have a single layer structure or a multilayer structure in which plural foam layers are laminated. Since the foamed resin composition as a material has a high melt viscosity, distribution of the air bubbles 11 included in the foamed insulation layer 12 (the foamed state of the foamed insulation layer 12) is highly uniform.

For example, gas is injected into the molten resin of the foamed resin composition in an extruder at the time of extrusion-molding of the wire 1 so that the resin composition is foamed by pressure difference between inside and outside of the extruder, thereby obtaining the foamed insulation layer 12 including the air bubbles 11.

The wire 1 has the foamed insulation layer 12 formed of the foamed resin composition in the first embodiment and is thus excellent in uniformity of the foamed state, heat resistance and flame retardancy.

### Third Embodiment

### Cable

It is possible to use the foamed resin composition in the first embodiment as a material of a foamed insulation layer of a cable. In the cable, the foamed insulation layer is formed on a conductor or on another layer on the conductor. An example of the cable will be described below.

FIG. 2 is a cross sectional view showing a cable 2 in a third embodiment. The cable 2 has the conductor 10, an inner skin layer 21 on the conductor 10, the foamed insulation layer 12 on the inner skin layer 21, an outer skin layer 22 on the foamed insulation layer 12, a shield 31 on the outer skin layer 22, and a sheath 32 on the shield 31.

The same conductor 10 and the foamed insulation layer 12 as those of the wire 1 in the second embodiment can be used as those of the cable 2.

The inner skin layer 21 and the outer skin layer 22 are formed of, e.g., a resin, and do not contain air bubbles or has an extremely lower foaming degree than the foamed insulation layer 12 (with extremely few air bubbles). The inner skin layer 21 enhances adhesion between the foamed insulation layer 12 and the conductor 10. The outer skin layer 22 suppresses a decrease in the foaming degree caused by outgassing from the foamed insulation layer 12 at the time of extrusion-molding of the cable 2. The inner skin layer 21 and the outer skin layer 22 may not be necessarily included in the cable 2 as long as the cable 2 has sufficient characteristics.

The shield 31 is a served or braided very fine metal wire, a wrapped metal foil or a metal film having a corrugated structure. The sheath 32 is formed of, e.g., polyolefin such as polyethylene, polypropylene and ethylene-vinyl acetate copolymer, etc., fluorine resin or soft vinyl chloride resin.

The wire 1 has the foamed insulation layer 12 formed of the foamed resin composition in the first embodiment and is thus excellent in uniformity of the foamed state, heat resistance and flame retardancy.

### Fourth Embodiment

### Twinax Cable

It is possible to use the foamed resin composition in the first embodiment as a material of a foamed insulation layer of a twinax cable (i.e., a two-core parallel coaxial cable). The twinax cable is a high-speed transmission cable compatible with high-speed differential transmission, and has two parallel wires and a shield covering an outer periphery thereof. In addition, a drain wire parallel to the two wires and in contact with the inside of the shield may be included.

In the twinax cable, a signal transmission time difference between two wires (delay time difference: skew) must be suppressed. This is to prevent communication errors in a device receiving signals caused by occurrence of time difference between signals transmitted from plural wires. Skew is a delay time difference between individual wires and significantly relates to a dielectric constant of the insulation of the wire. Therefore, the foaming degree of the insulation is the most important factor of the skew. An example of the twinax cable will be described below.

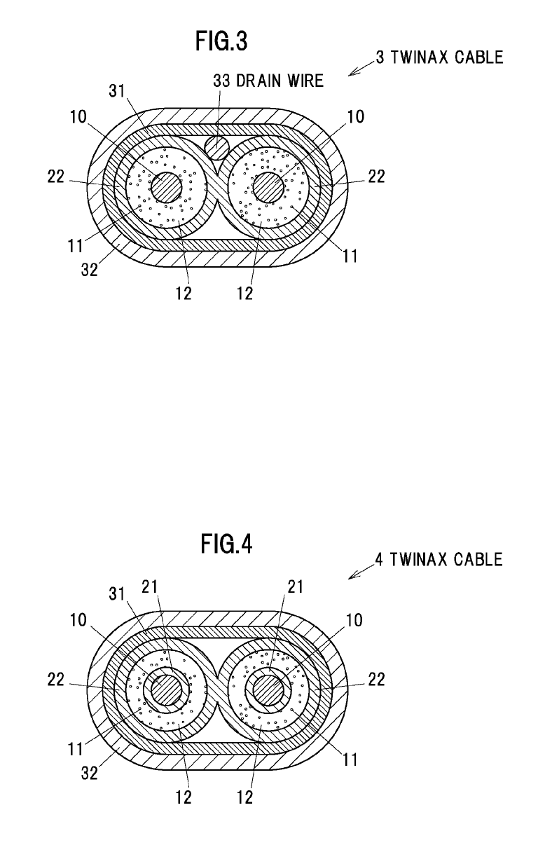

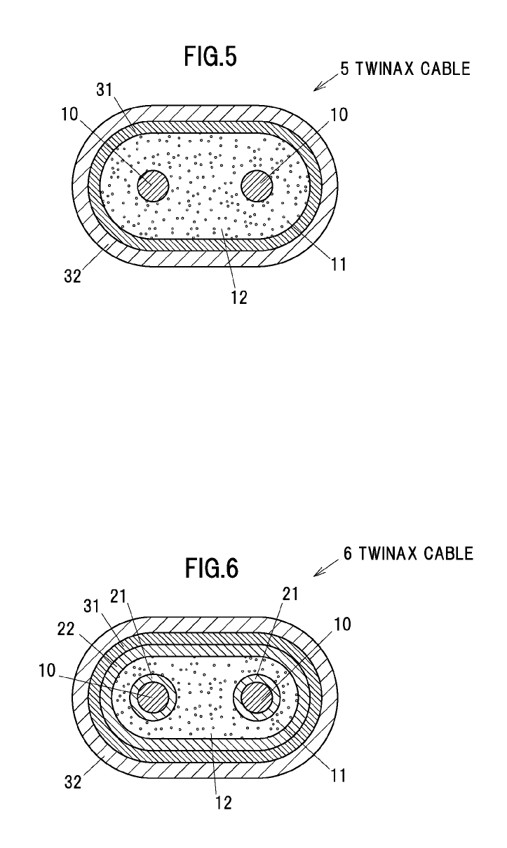

FIGS. 3 to 6 are cross sectional views showing twinax cables 3 to 6 in a fourth embodiment.

The twinax cable 3 has two wires each composed of the conductor 10, the foamed insulation layer 12 and the outer skin layer 22, a drain wire 33 parallel to the two wires, the shield 31 covering the two wires as well as the drain wire 33, and the sheath 32 on the shield 31.

The same conductor 10, the foamed insulation layer 12, the outer skin layer 22, the shield 31 and the sheath 32 as those in the third embodiment can be used as those of the twinax cable 3.

The drain wire 33 is a conductor wire arranged between the shield 31 and the outer skin layer 22, and is connected to a ground of a substrate.

The twinax cable 4 has two wires each composed of the conductor 10, the inner skin layer 21, the foamed insulation layer 12 and the outer skin layer 22, the shield 31 covering the two wires, and the sheath 32 on the shield 31.

The twinax cable 5 has two conductors 10, the foamed insulation layer 12 covering the two conductors 10, the shield 31 on the foamed insulation layer 12, and the sheath 32 on the shield 31.

The twinax cable 6 has two wires each composed of the conductor 10 and the inner skin layer 21, the foamed insulation layer 12 covering the two wires, the outer skin layer 22 on the foamed insulation layer 12, the shield 31 on the outer skin layer 22, and the sheath 32 on the shield 31.

Since the twinax cables 4 to 6 do not have a drain wire, the shield 31 is directly connected to a grand of a substrate by soldering. Therefore, heat resistance of the foamed insulation layer 12 is more important than in the twinax cable 3 having the drain wire 33.

The twinax cables 3 to 6 have the foamed insulation layer 12 formed of the foamed resin composition in the first embodiment and are thus excellent in uniformity of the foamed state, heat resistance and flame retardancy. In addition, it is possible to suppress the skew.

### EXAMPLES

Foamed resin compositions, wires and twinax cables in Examples and Comparative Examples were made and the following various evaluations were conducted.

### Manufacturing of Wire

The foamed resin composition was foam-molded on a 24 AWG silver-plated copper conductor as the conductor 10, thereby forming the foamed insulation layer 12. The foamed insulation layer 12 was formed by continuously operating a 45 mm gas injection foaming extruder for 2000 seconds while adjusting screw revolution speed and linear velocity so that the wire 1 has an outer diameter of 1.46 mm. As a foaming gas, a nitrogen gas was used at gas pressure of 39 MPa.

### Measurement of Variation in Foaming Degree Over Time

The outer diameter and capacitance of the wire 1 were measured every 0.2 seconds at the time of extruding the wire 1 and an effective dielectric constant εᵣ was calculated according to the following formula 1.

$${ɛ}_{r} = \frac{C \cdot ln ( b / a )}{2 π \cdot {ɛ}_{0}} \qquad Formula 1$$

Here, ε₀ is a dielectric constant of the air, C is capacitance, b is the outer diameter of the wire 1 and a is the outer diameter of the conductor 10.

Next, the converted foaming degree F. at each measurement time was calculated according to the following formula 2. The smaller the variation in the foaming degree F. over time, the higher the uniformity of the foamed state of the foamed insulation layer 12 (uniformity of distribution of the air bubbles 11).

$$F = \frac{2 {ɛ}_{r} + 1}{3 {ɛ}_{r}} \times \frac{{ɛ}_{i} - {ɛ}_{r}}{{ɛ}_{i} - 1} \qquad Formula 2$$

Here, εᵢ indicates a dielectric constant of the resin composition.

A difference between the maximum and minimum values of the calculated foaming degree F (%) was defined as variation in the foaming degree. As a criterion for evaluating variation in the foaming degree, not more than 4.3% was regarded as acceptable in view of transmission characteristics.

### Manufacturing of Twinax Cable

Two above-mentioned wires were arranged in parallel, a laminated tape formed by laminating a copper tape and a polyester film was wound therearound to form the shield 31, and the outside thereof was further covered with a soft vinyl chloride resin to form the sheath 32, thereby obtaining a 30 m-long twinax cable.

### Measurement of Skew

Six 5 m-long twinax cables were obtained by cutting the manufactured twinax cable. Skew was measured on each of the six twinax cables by TDR (time-domain reflectometer). As a criterion for evaluating skew, not more than 25 ps/m was regarded as acceptable.

### Solder Heat Resistance Test

The sheath at an end of the twinax cable was removed, a pulse-type solder heating tool of which tip portion is heated to 270° C. was pressed against the exposed foamed insulation layer 12 at 1 N for 3 seconds, thereby forming a Pb-free solder joint. As an evaluation criterion of solder heat resistance test, the sample in which formation of the Pb-free solder joint did not cause deformation of the foamed insulation layer 12 was regarded as acceptable.

### Flame Retardancy Test

Flame retardancy was evaluated by conducting two types of flame tests with different requirement levels, i.e., a 45-degree inclined flame test in accordance with ISO 6722 and a vertical flame test in accordance with UL1581 (VW-1) of which flame retardancy level is more strict. As an evaluation criterion of flame retardancy test, the sample which passed only the 45-degree inclined flame test was regarded as G (good) and the sample which passed also the more strict VW-1 test was regarded as E (excellent).

The evaluation results of constituents of foamed resin compositions in Examples 1 to 15 and Comparative Examples 1 to 8, and the wires and the twinax cables manufactured using the foamed resin compositions will be described below.

### Example 1

A foamed resin composition was prepared by blending 10 parts by weight of low-density polyethylene (LDPE) (density: 928 kg/m³, MFR: 0.5) with 90 parts by weight of syndiotactic polystyrene (SPS) (S104, manufactured by Idemitsu Kosan Co., Ltd.). As the evaluation result, the foamed resin composition passed all evaluations (the comprehensive evaluation: “◯” (good)).

### Example 2

A foamed resin composition was prepared by blending 30 parts by weight of low-density polyethylene (density: 928 kg/m³, MFR: 0.5) with 70 parts by weight of syndiotactic polystyrene (S104, manufactured by Idemitsu Kosan Co., Ltd.). As the evaluation result, the foamed resin composition passed all evaluations (the comprehensive evaluation: “◯”).

### Example 3

A foamed resin composition was prepared by blending 30 parts by weight of low-density polyethylene (density: 928 kg/m³, MFR: 0.5) as well as 0.5 parts by weight of molybdenum disulfide with 70 parts by weight of syndiotactic polystyrene (S104, manufactured by Idemitsu Kosan Co., Ltd.). As the evaluation result, the foamed resin composition passed all evaluations and was excellent especially in flame retardancy, hence, the comprehensive evaluation was “⊚ (excellent)”).

### Example 4

A foamed resin composition was prepared by blending 1 part by weight of surface treated PTFE powder (average particle size: about 300 μm, acrylic surface-treated product) with 100 parts by weight of syndiotactic polystyrene (S104, manufactured by Idemitsu Kosan Co., Ltd.). As the evaluation result, the foamed resin composition passed all evaluations (the comprehensive evaluation: “◯”).

### Example 5

A foamed resin composition was prepared by blending 3 parts by weight of surface treated PTFE powder (average particle size: about 300 μm, acrylic surface-treated product) with 100 parts by weight of syndiotactic polystyrene (S104, manufactured by Idemitsu Kosan Co., Ltd.). As the evaluation result, the foamed resin composition passed all evaluations (the comprehensive evaluation: “◯”).

### Example 6

A foamed resin composition was prepared by blending 5 parts by weight of surface treated PTFE powder (average particle size: about 300 μm, acrylic surface-treated product) with 100 parts by weight of syndiotactic polystyrene (S104, manufactured by Idemitsu Kosan Co., Ltd.). As the evaluation result, the foamed resin composition passed all evaluations (the comprehensive evaluation: “◯”).

### Example 7

A foamed resin composition was prepared by blending 1 part by weight of surface treated PTFE powder (average particle size: about 300 μm acrylic surface-treated product) as well as 0.5 parts by weight of boron nitride with 100 parts by weight of syndiotactic polystyrene (S104, manufactured by Idemitsu Kosan Co., Ltd.). As the evaluation result, the foamed resin composition passed all evaluations and was excellent especially in flame retardancy, hence, the comprehensive evaluation was “⊚”.

### Example 8

A foamed resin composition was prepared by blending 3 parts by weight of surface treated PTFE powder (average particle size: about 300 μm, acrylic surface-treated product) as well as 0.5 parts by weight of boron nitride with 100 parts by weight of syndiotactic polystyrene (S104, manufactured by Idemitsu Kosan Co., Ltd.). As the evaluation result, the foamed resin composition passed all evaluations and was excellent especially in flame retardancy, hence, the comprehensive evaluation was “⊚”.

### Example 9

A foamed resin composition was prepared by blending 5 parts by weight of surface treated PTFE powder (average particle size: about 300 μm, acrylic surface-treated product) as well as 0.5 parts by weight of boron nitride with 100 parts by weight of syndiotactic polystyrene (S104, manufactured by Idemitsu Kosan Co., Ltd.). As the evaluation result, the foamed resin composition passed all evaluations and was excellent especially in flame retardancy, hence, the comprehensive evaluation was “⊚”.

### Example 10

A foamed resin composition was prepared by blending 0.5 parts by weight of surface treated PTFE powder (average particle size: about 300 μm, acrylic surface-treated product) with 100 parts by weight of syndiotactic polystyrene (S104, manufactured by Idemitsu Kosan Co., Ltd.). As the evaluation result, the foamed resin composition passed all evaluations (the comprehensive evaluation: “◯”).

### Example 11

A foamed resin composition was prepared by blending 10 parts by weight of surface treated PTFE powder (average particle size: about 300 μm, acrylic surface-treated product) with 100 parts by weight of syndiotactic polystyrene (S104, manufactured by Idemitsu Kosan Co., Ltd.). As the evaluation result, the foamed resin composition passed all evaluations (the comprehensive evaluation: “∘”).

### Example 12

A foamed resin composition was prepared by blending 3 parts by weight of PTFE powder (average particle size: about 10 μm, not surface-treated) with 100 parts by weight of syndiotactic polystyrene (S104, manufactured by Idemitsu Kosan Co., Ltd.). As the evaluation result, the foamed resin composition passed all evaluations (the comprehensive evaluation: “∘”).

### Example 13

A foamed resin composition was prepared by blending 5 parts by weight of PTFE powder (average particle size: about 10 μm, not surface-treated) with 100 parts by weight of syndiotactic polystyrene (S104, manufactured by Idemitsu Kosan Co., Ltd.). As the evaluation result, the foamed resin composition passed all evaluations (the comprehensive evaluation: “∘”).

### Example 14

A foamed resin composition was prepared by blending 3 parts by weight of PTFE powder (average particle size: about 10 μm, not surface-treated) as well as 0.5 parts by weight of boron nitride with 100 parts by weight of syndiotactic polystyrene (S104, manufactured by Idemitsu Kosan Co., Ltd.). As the evaluation result, the foamed resin composition passed all evaluations and was excellent especially in flame retardancy, hence, the comprehensive evaluation was “⊚”.

### Example 15

A foamed resin composition was prepared by blending 5 parts by weight of PTFE powder (average particle size: about 10 μm, not surface-treated) as well as 0.5 parts by weight of boron nitride with 100 parts by weight of syndiotactic polystyrene (S104, manufactured by Idemitsu Kosan Co., Ltd.). As the evaluation result, the foamed resin composition passed all evaluations and was excellent especially in flame retardancy, hence, the comprehensive evaluation was “⊚”.

### Comparative Example 1

Syndiotactic polystyrene (S104, manufactured by Idemitsu Kosan Co., Ltd.) was used alone as a foamed resin composition. As the evaluation result, the foamed resin composition failed the evaluations of variation in the foaming degree, skew and flame retardancy (the comprehensive evaluation: “× (NG)”). The reason for this is considered that neither polyolefin nor PTFE for adjusting viscosity is added and thus variation in the foaming degree is not suppressed.

### Comparative Example 2

A foamed resin composition was prepared by blending 2 parts by weight of low-density polyethylene (density: 928 kg/m³, MFR: 0.5) with 98 parts by weight of syndiotactic polystyrene (S104, manufactured by Idemitsu Kosan Co., Ltd.). As the evaluation result, the foamed resin composition failed the evaluations of variation in the foaming degree and skew (the comprehensive evaluation: “×”). The reason for this is considered that the mixed amount of the polyolefin is less than the defined amount and thus variation in the foaming degree is not suppressed.

### Comparative Example 3

A foamed resin composition was prepared by blending 40 parts by weight of low-density polyethylene (density: 928 kg/m³, MFR: 0.5) with 60 parts by weight of syndiotactic polystyrene (S104, manufactured by Idemitsu Kosan Co., Ltd.). As the evaluation result, the foamed resin composition failed the evaluations of solder heat resistance and flame retardancy (the comprehensive evaluation: “×”). The reason for this is considered that, although variation in the foaming degree is suppressed since a proportion of the polyolefin is large, heat resistance decreases due to a small proportion of the syndiotactic polystyrene, resulting in poor solder connectivity and insufficient flame retardancy.

### Comparative Example 4

A foamed resin composition was prepared by blending 0.5 parts by weight of molybdenum disulfide with 100 parts by weight of syndiotactic polystyrene (S104, manufactured by Idemitsu Kosan Co., Ltd.). As the evaluation result, the foamed resin composition failed the evaluation of flame retardancy (the comprehensive evaluation: “×”). From this, it was confirmed that sufficient flame retardancy is not exhibited only by blending an inorganic compound having a layered crystal structure alone with syndiotactic polystyrene and flame retardancy is improved by a synergetic effect of the polyolefin resin or the fluorine-resin-containing powder and the inorganic compound having a layered crystal structure.

### Comparative Example 5

A foamed resin composition was prepared by blending 3 parts by weight of surface treated PTFE powder (average particle size: about 300 μm, acrylic surface-treated product) as well as 0.5 parts by weight of boron nitride with 100 parts by weight of low-density polyethylene (density: 928 kg/m³, MFR: 0.5). As the evaluation result, the foamed resin composition failed the evaluations of solder heat resistance and flame retardancy (the comprehensive evaluation: “×”). The reason for this is considered that syndiotactic polystyrene is not contained and thus heat resistance is not sufficient.

### Comparative Example 6

A foamed resin composition was prepared by blending 0.5 parts by weight of boron nitride with 100 parts by weight of syndiotactic polystyrene (S104, manufactured by Idemitsu Kosan Co., Ltd.). As the evaluation result, the foamed resin composition failed the evaluations of skew and flame retardancy (the comprehensive evaluation: “×”). The reason for this is considered that the polyolefin resin or the fluorine-resin-containing powder is not contained and thus variation in the foaming degree is not suppressed.

### Comparative Example 7

A foamed resin composition was prepared by blending 12 parts by weight of boron nitride with 100 parts by weight of syndiotactic polystyrene (S104, manufactured by Idemitsu Kosan Co., Ltd.). As the evaluation result, the foamed resin composition failed the evaluations of variation in the foaming degree, skew and flame retardancy (the comprehensive evaluation: “×”). The reason for this is considered that the polyolefin resin or the fluorine-resin-containing powder is not contained and thus variation in the foaming degree is not suppressed and flame retardancy is not obtained, neither.

### Comparative Example 8

A foamed resin composition was prepared by blending 12 parts by weight of surface treated PTFE powder (average particle size: about 300 μm, acrylic surface-treated product) with 100 parts by weight of syndiotactic polystyrene (S104, manufactured by Idemitsu Kosan Co., Ltd.). As the evaluation result, the foamed resin composition failed the evaluations of variation in the foaming degree and skew (the comprehensive evaluation: “×”). The reason for this is considered that the added amount of the PTFE powder is too large and thus the foaming degree largely varies.

Following Tables 1, 2, 3 and 4 respectively shows the constituents of the foamed resin compositions as well as the evaluation results of the wires and the cables in Examples 1 to 3, those in Examples 4 to 11, those in Examples 12 to 15 and those in Comparative Examples 1 to 8.

TABLE 1

| | | Example 1 | Example 2 | Example 3 |
|---|---|---|---|---|
| Constituent | SPS | 90 | 70 | 70 |
| | LDPE | 10 | 30 | 30 |
| | Molybdenum disulfide | | | 0.5 |
| Evaluation | Variation in foaming | 3.56 | 2.64 | 1.51 |
| | degree [%] | | | |
| | Skew [ps/m] | 13.7 | 6.8 | 2.9 |
| | Solder heat resistance | ◯ | ◯ | ◯ |
| | Flame retardancy | Good | Good | Excellent |

| | | | |
|---|---|---|---|
| Comprehensive evaluation | ◯ | ◯ | ⊚ |

TABLE 2

| | | Example 4 | Example 5 | Example 6 | Example 7 | Example 8 | Example 9 | Example 10 | Example 11 |
|---|---|---|---|---|---|---|---|---|---|
| Constituent | SPS | 100 | 100 | 100 | 100 | 100 | 100 | 100 | 100 |
| | PTFE powder | 1 | 3 | 5 | 1 | 3 | 5 | 0.5 | 10 |
| | Boron nitride | | | | 0.5 | 0.5 | 0.5 | | |
| Evaluation | Variation in | 3.86 | 3.43 | 2.8 | 2.6 | 1.21 | 2.09 | 4.25 | 4.02 |
| | foaming degree | | | | | | | | |
| | [%] | | | | | | | | |
| | Skew [ps/m] | 17.3 | 12.4 | 7.7 | 6.6 | 2.3 | 4.5 | 23.1 | 22.7 |
| | Solder heat | ◯ | ◯ | ◯ | ◯ | ◯ | ◯ | ◯ | ◯ |
| | resistance | | | | | | | | |
| | Flame retardancy | Good | Good | Good | Excellent | Excellent | Excellent | Good | Good |

| | | | | | | | | |
|---|---|---|---|---|---|---|---|---|
| Comprehensive evaluation | ◯ | ◯ | ◯ | ⊚ | ⊚ | ⊚ | ◯ | ◯ |

TABLE 3

| | | Example 12 | Example 13 | Example 14 | Example 15 |
|---|---|---|---|---|---|
| Constituent | SPS | 100 | 100 | 100 | 100 |
| | PTFE powder | 3 | 5 | 3 | 5 |
| | Boron nitride | | | 0.5 | 0.5 |
| Evaluation | Variation in foaming degree [%] | 4.13 | 3.95 | 2.76 | 1.49 |
| | Skew [ps/m] | 21.2 | 18.4 | 7.5 | 2.8 |
| | Solder heat resistance | ◯ | ◯ | ◯ | ◯ |
| | Flame retardancy | Good | Good | Excellent | Excellent |

| | | | | |
|---|---|---|---|---|
| Comprehensive evaluation | ◯ | ◯ | ⊚ | ⊚ |

TABLE 4

| | | Comparative | Comparative | Comparative | Comparative | Comparative | Comparative | Comparative | Comparative |
|---|---|---|---|---|---|---|---|---|---|
| | | Example 1 | Example 2 | Example 3 | Example 4 | Example 5 | Example 6 | Example 7 | Example 8 |
| Constituent | SPS | 100 | 98 | 60 | 100 | | 100 | 100 | 100 |
| | LDPE | | 2 | 40 | | 100 | | | |
| | PTFE powder | | | | | 3 | | | 12 |
| | Molybdenum | | | | 0.5 | | | | |
| | disulfide | | | | | | | | |
| | Boron nitride | | | | | 0.5 | 0.5 | 12 | |
| Evaluation | Variation in | 4.53 | 4.41 | 2.31 | 2.71 | 1.97 | 4.21 | 4.42 | 4.51 |
| | foaming degree | | | | | | | | |
| | [%] | | | | | | | | |
| | Skew [ps/m] | 28.7 | 26.1 | 5.3 | 7.2 | 4.1 | 26.2 | 26.7 | 28.2 |
| | Solder heat | ◯ | ◯ | X | ◯ | X | ◯ | ◯ | ◯ |
| | resistance | | | | | | | | |
| | Flame | NG | Good | NG | NG | NG | NG | NG | Good |
| | retardancy | | | | | | | | |
| Comprehensive | | X | X | X | X | X | X | X | X |
| evaluation | | | | | | | | | |

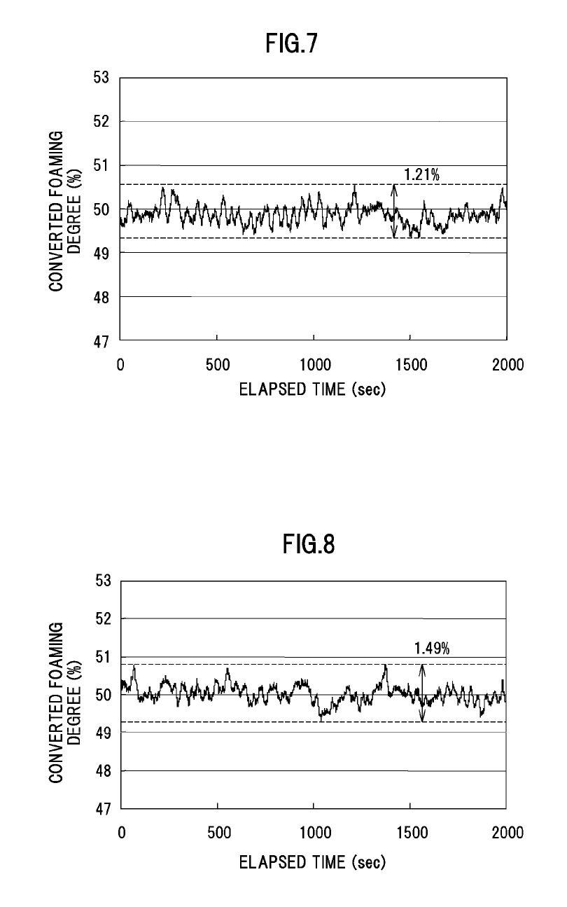

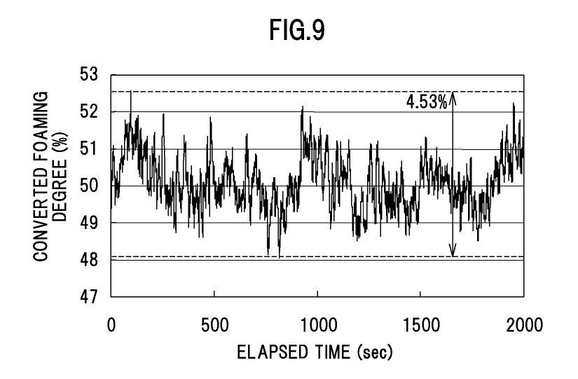

FIGS. 7, 8 and 9 are graphs respectively showing variation in the converted foaming degree F. over time in Example 8, that in Example 15 and that in Comparative Example 1. It is shown that respective variations in the foaming degree (a difference between the maximum and minimum values of the converted foaming degree F. in 2000 seconds) are 1.21%, 1.49% and 4.53%.

As described above, the comprehensive evaluation was “⊚ (excellent)” in Examples 3, 7, 8, 9, 14 and 15 in which a foamed resin composition equivalent to the foamed resin composition of the embodiment is used. The comprehensive evaluation of other Examples was “◯ (good)” since flame retardancy was inferior to Examples 3, 7, 8, 9, 14 and 15. The comprehensive evaluation was “×(NG)” in any of Comparative Examples 1 to 8.

Although the embodiments and Examples of the invention have been described, the invention according to claims is not to be limited to the above-mentioned embodiments and Examples. Further, please note that not all combinations of the features described in the embodiments and Examples are not necessary to solve the problem of the invention.

What is claimed is:

1. A foamed resin composition, comprising:
syndiotactic polystyrene; and
a polyolefin resin of not less than 5.3 parts by weight and not more than 54 parts by weight relative to 100 parts by weight of the syndiotactic polystyrene.

2. The foamed resin composition according to claim 1, further comprising:
an inorganic compound with a layered crystal structure.

3. The foamed resin composition according to claim 2, wherein the inorganic compound comprises clay, boron nitride, molybdenum disulfide, tungsten disulfide, melamine cyanurate, mica, talc, glass flake and hydrotalcite.

4. A foamed resin composition, comprising:
syndiotactic polystyrene; and
fluorine-resin-containing powder of not less than 0.5 parts by weight and not more than 10 parts by weight relative to 100 parts by weight of the syndiotactic polystyrene.

5. The foamed resin composition according to claim 4, further comprising:
an inorganic compound with a layered crystal structure.

6. The foamed resin composition according to claim 5, wherein the inorganic compound comprises clay, boron nitride, molybdenum disulfide, tungsten disulfide, melamine cyanurate, mica, talc, glass flake and hydrotalcite.

7. A wire, comprising:
a conductor; and
a foamed insulation layer on the conductor or on another layer on the conductor,
wherein the foamed insulation layer mainly comprises the foamed resin composition according to claim 1.

8. A wire, comprising:
a conductor; and
a foamed insulation layer on the conductor or on another layer on the conductor,
wherein the foamed insulation layer mainly comprises the foamed resin composition according to claim 3.

9. A cable, comprising:
a conductor;
a foamed insulation layer on the conductor or on another layer on the conductor;
a shield on the foamed insulation layer or on another layer on the foamed insulation layer; and
a sheath on the shield or on another layer on the shield,
wherein the foamed insulation layer mainly comprises the foamed resin composition according to claim 1.

10. The cable according to claim 9, wherein the conductor comprises two parallel conductor wires.

11. A cable, comprising:
a conductor;
a foamed insulation layer on the conductor or on another layer on the conductor;
a shield on the foamed insulation layer or on another layer on the foamed insulation layer; and
a sheath on the shield or on another layer on the shield,
wherein the foamed insulation layer mainly comprises the foamed resin composition according to claim 3.

12. The cable according to claim 11, wherein the conductor comprises two parallel conductor wires.
